(19) United States
(12) Patent Application Publication
(10) Pub. No.: US 2025/0129926 A1
(43) Pub. Date: Apr. 24, 2025

(54) Lampshade Assembly and Snoot Tube Applying Same

(71) Applicant: Hongjie Chen, Shenzhen (CN)

(72) Inventors: Hongjie Chen, Shenzhen (CN); Wei Ma, Shenzhen (CN)

(21) Appl. No.: 18/768,043

(22) Filed: Jul. 10, 2024

(30) Foreign Application Priority Data
Oct. 19, 2023 (CN) 202322817112.3

(51) Int. Cl. F21V 29/83; F21V 3/02; F21V 5/04; F21V 29/60

(52) U.S. Cl. CPC F21V 29/83; F21V 3/02; F21V 5/043; F21V 29/60

(57) ABSTRACT

The present application belongs to the field of lamps and lanterns, and more particularly, relates to a lampshade assembly. The lampshade assembly includes a first lampshade and a second lampshade, wherein the first lampshade is arranged to sleeve the outside of the second lampshade; a lamp housing heat-dissipation channel is formed between the first lampshade and the second lampshade; lampshade heat-dissipation holes are formed in the first lampshade; and a light-condensing channel is arranged in the second lampshade. In the present application, this lampshade assembly can play a role in preventing light leakage, and can also better dissipate heat from a lamp through the lamp housing heat-dissipation channel and the lampshade heat-dissipation holes.

### CROSS REFERENCE TO RELATED APPLICATIONS

The present application claims the benefit of Chinese Patent Application No. 202322817112.3 filed on Oct. 19, 2023, the contents of which are incorporated herein by reference in their entirety.

### TECHNICAL FIELD

The present application belongs to the field of lamps and lanterns, and more particularly, relates to a lampshade assembly.

### BACKGROUND ART

When a lamp works, in order to ensure a luminous effect of the lamp, a lampshade structure needs to be arranged to prevent the lamp from light leakage. However, a lampshade with a good light leakage prevention effect often has a poor heat dissipation effect; and when the lamp emits light, part of the energy will be converted into heat, such that the temperature of the lamp raises, which will cause the aging of a chip of the lamp to be accelerated and shorten the service life of the chip. Therefore, a lampshade with a poor heat dissipation effect will affect the service life of the lamp.

### SUMMARY OF THE INVENTION

In order to solve the problem, an object of the present application is to provide a lampshade assembly. The lampshade assembly not only has a good light leakage prevention effect, but also has a good heat dissipation effect.

In order to fulfill the above object, the technical solution of the present application is summarized as follows.

A lampshade assembly is provided. The lampshade assembly includes a first lampshade and a second lampshade, wherein the first lampshade is arranged to sleeve the outside of the second lampshade; a lamp housing heat-dissipation channel is formed between the first lampshade and the second lampshade; lampshade heat-dissipation holes that penetrate to the lamp housing heat-dissipation channel are formed in the first lampshade; a light-condensing channel is arranged in the second lampshade; one end of the light-condensing channel penetrates through one end of the second lampshade to form a light-condensing inlet corresponding to a lamp; and the other end of the light-condensing channel runs through the other end of the second lampshade to form a light-condensing outlet.

In this lampshade assembly, the second lampshade is used for condensing light for the lamp through the light-condensing channel and plays the role of preventing light leakage; and the first lampshade can also play a certain role in preventing light leakage, and further enhance a light leakage prevention effect of the lampshade assembly. However, based on the settings of the lamp housing heat-dissipation channel between the first lampshade and the second lampshade, as well as the lampshade heat-dissipation holes formed in the first lampshade, when the lampshade assembly is used in cooperation the lamp, the lamp can be better dissipated in heat through the lamp housing heat-dissipation channel and the lampshade heat-dissipation hole in order to avoid the temperature of the lamp from being too high.

Further, the lamp housing heat-dissipation channel is encircled between the inner side of the first lampshade and the outer side of the second lampshade, and a plurality of lampshade heat-dissipation holes is encircled in the first lampshade. Due to the above settings, this lampshade assembly has a better heat-dissipation effect.

Further, the lampshade assembly further includes a connector; the connector is arranged between the first lampshade and the second lampshade; and inner and outer sides of the connector are detachably connected to the second lampshade and the first lampshade respectively through threads.

Further, the light-condensing inlet has a diameter less than a diameter of the light-condensing outlet.

Further, the second lampshade is trumpet-shaped as a whole.

A snoot tube is provided. The snoot tube includes the lampshade assembly, a lamp mechanism and a lens mechanism, wherein the lamp mechanism and the lens mechanism are respectively arranged at two ends of the lampshade assembly, the lampshade assembly corresponds to the light-condensing inlet, and the lens mechanism corresponds to the light-condensing outlet.

In this snoot tube, the lamp mechanism is used for emitting light, and the light emitted by the lamp mechanism is condensed after passing through the lampshade assembly, and then focused after passing through the lens mechanism. Specifically, in this snoot tube, the second lampshade is used for condensing light for the lamp through the light-condensing channel and plays the role of preventing light leakage; and the first lampshade can also play a certain role in preventing light leakage, and further enhance a light leakage prevention effect of the lampshade assembly. However, based on the settings of the lamp housing heat-dissipation channel between the first lampshade and the second lampshade, as well as the lampshade heat-dissipation holes formed in the first lampshade, when the lampshade assembly is used in cooperation the lamp mechanism, the lamp can be better dissipated in heat through the lamp housing heat-dissipation channel and the lampshade heat-dissipation holes in order to avoid the temperature of the lamp from being too high.

Further, the lamp mechanism and the lens mechanism are detachably arranged at two ends of the first lampshade respectively.

Further, the lamp mechanism includes a lamp housing, a heat-dissipation fan, a heat radiator, and a lamp panel; the lamp housing is detachably connected to the first lampshade; lamp heat-dissipation holes are formed in the lamp housing, and the heat-dissipation fan, the heat radiator and the lamp panel are all arranged in the lamp housing; the lamp panel is fixedly arranged on one side of the heat radiator; the heat-dissipation fan corresponds to the other side of the heat radiator; and the lamp panel corresponds to the light-condensing inlet; and
a heat-dissipation path is formed in the snoot tube, and the heat-dissipation path passes through the lamp heat-dissipation holes, the heat-dissipation fan, the heat radiator, the lamp panel, the lamp housing heat-dissipation channel, and the lampshade heat-dissipation hole in sequence.

Further, the lens mechanism includes a first cylinder, a second cylinder and a lens group including at least one lens; the first cylinder is telescopically connected to the second cylinder; the at least one lens is arranged in the first cylinder; the first cylinder is provided with a light outlet, the second cylinder is provided with a light inlet, and the light inlet and the light outlet are communicated to form an optical channel; and the light inlet corresponds to the light-condensing outlet.

Further, the projection assembly further includes a projection assembly provided with a pattern, the projection assembly is detachably arranged in the second cylinder, and the projection assembly is located in the optical channel.

In the present application, the present application has the following beneficial effects: the second lampshade is used for condensing light for the lamp through the light-condensing channel and plays the role of preventing light leakage; and the first lampshade can also play a certain role in preventing light leakage, and further enhance a light leakage prevention effect of the lampshade assembly. However, based on the settings of the lamp housing heat-dissipation channel between the first lampshade and the second lampshade, as well as the lampshade heat-dissipation holes formed in the first lampshade, when the lampshade assembly is used in cooperation the lamp, the lamp can be better dissipated in heat through the lamp housing heat-dissipation channel and the lampshade heat-dissipation holes in order to avoid the temperature of the lamp from being too high.

### BRIEF DESCRIPTION OF THE DRAWINGS

FIG. 1 is a schematic structural diagram of a lampshade assembly from a first perspective.

FIG. 2 is a schematic structural diagram of the lampshade assembly from a second perspective.

FIG. 3 is a schematic exploded view of the lampshade assembly.

FIG. 4 is a schematic structural diagram of a snoot tube.

FIG. 5 is a sectional view of a lamp mechanism.

FIG. 6 is a schematic structural diagram of a lens mechanism from a first perspective.

FIG. 7 is a schematic structural diagram of the lens mechanism from a second perspective.

FIG. 8 is a schematic exploded view of the lens mechanism.

### DETAILED DESCRIPTION OF THE INVENTION

To make the objectives, technical solutions, and advantages of the present application clearer, the following further describes the present application in detail with reference to the accompanying drawings and the embodiments. It should be understood that the specific embodiments described here are only used to explain the present application, but not used to limit the present application.

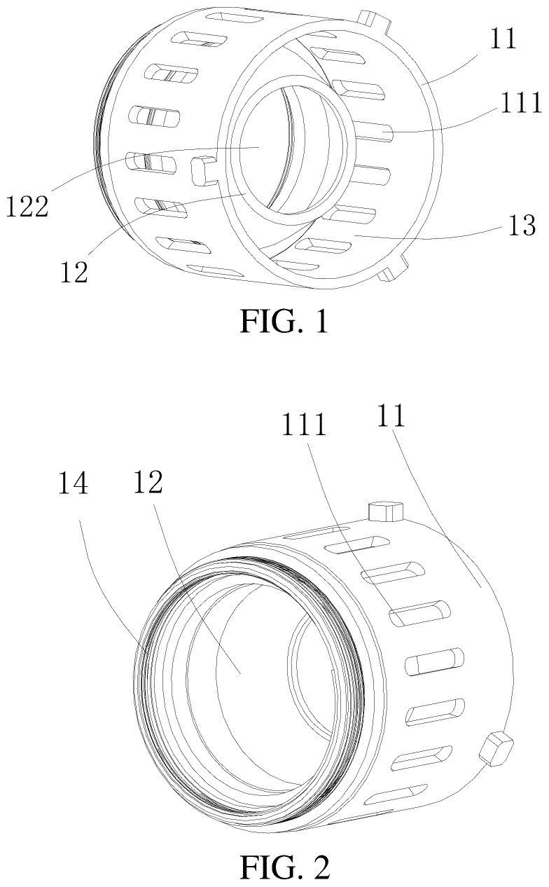

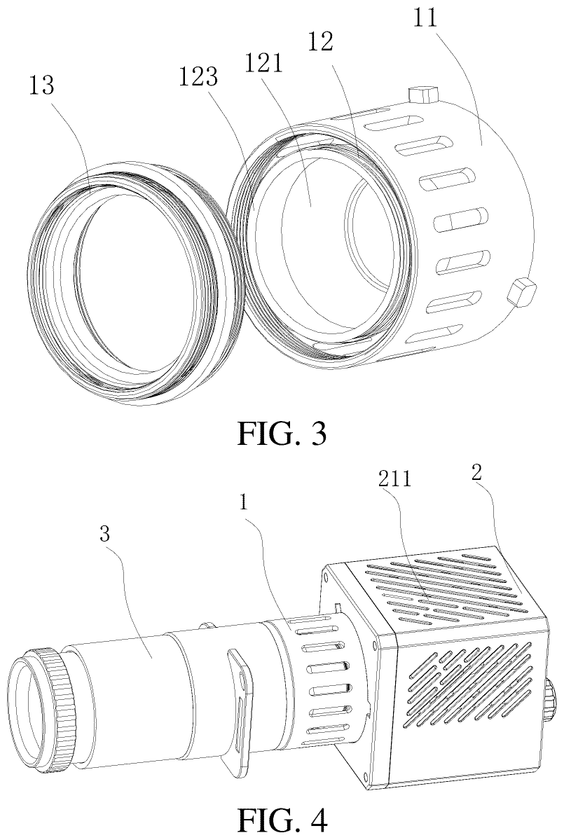

Referring to FIGS. 1-3, a lampshade assembly 1 is provided. The lampshade assembly 1 includes a first lampshade 11 and a second lampshade 12, wherein the first lampshade 11 is arranged to sleeve the outside of the second lampshade 12; a lamp housing heat-dissipation channel 13 is formed between the first lampshade 11 and the second lampshade 12; lampshade heat-dissipation holes 111 that penetrate to the lamp housing heat-dissipation channel 13 are formed in the first lampshade 11; a light-condensing channel 121 is arranged in the second lampshade; one end of the light-condensing channel 121 penetrates through one end of the second lampshade 12 to form a light-condensing inlet 122 corresponding to a lamp; and the other end of the light-condensing channel 121 runs through the other end of the second lampshade 12 to form a light-condensing outlet 123.

Further, the lamp housing heat-dissipation channel 13 is encircled between the inner side of the first lampshade 11 and the outer side of the second lampshade 12, and a plurality of lampshade heat-dissipation holes 111 is encircled in the first lampshade 11.

Further, the lampshade assembly 1 further includes a connector 14; the connector 14 is arranged between the first lampshade 11 and the second lampshade 12; and inner and outer sides of the connector 14 are detachably connected to the second lampshade 12 and the first lampshade 11 respectively through threads.

Further, the light-condensing inlet 122 has a diameter less than a diameter of the light-condensing outlet 123.

Further, the second lampshade 12 is trumpet-shaped as a whole.

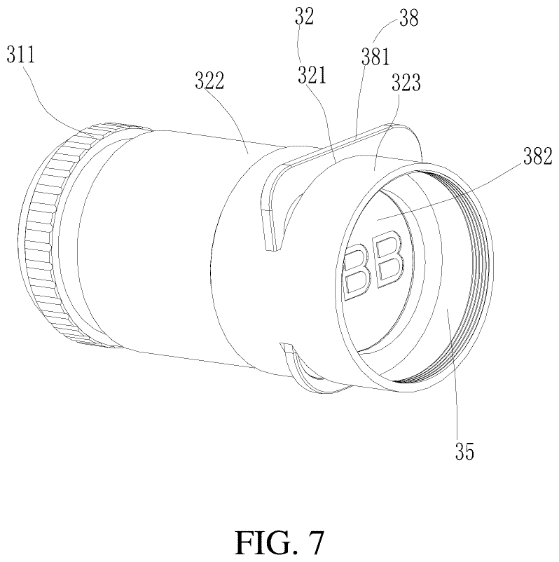

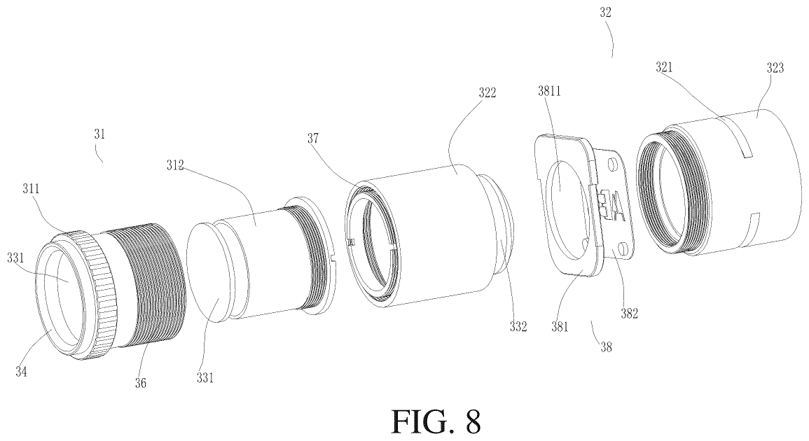

Referring to FIGS. 1-8, a snoot tube is provided. The snoot tube includes the lampshade assembly 1, a lamp mechanism 2 and a lens mechanism 3, wherein the lamp mechanism 2 and the lens mechanism 3 are respectively arranged at two ends of the lampshade assembly 1, the lampshade assembly 1 corresponds to the light-condensing inlet 122, and the lens mechanism 3 corresponds to the light-condensing outlet 123.

Further, the lamp mechanism 2 and the lens mechanism 3 are detachably arranged at two ends of the first lampshade 11 respectively. The detachable connection among them may be threaded connection or connection via a buckle or other structures.

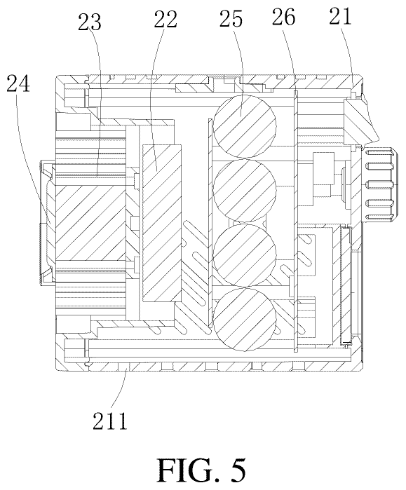

Referring to FIG. 5, further, the lamp mechanism 2 includes a lamp housing 21, a heat-dissipation fan 22, a heat radiator 23, and a lamp panel 24; the lamp housing 21 is detachably connected to the first lampshade 11; lamp heat-dissipation holes 211 are formed in the lamp housing 21, and the heat-dissipation fan 22, the heat radiator 23 and the lamp panel 24 are all arranged in the lamp housing 21; the lamp panel 24 is fixedly arranged on one side of the heat radiator 23; the heat-dissipation fan 22 corresponds to the other side of the heat radiator 23; and the lamp panel 24 corresponds to the light-condensing inlet 122; and
a heat-dissipation path is formed in the snoot tube, and the heat-dissipation path passes through the lamp heat-dissipation holes 211, the heat-dissipation fan 22, the heat radiator 23, the lamp panel 24, the lamp housing heat-dissipation channel 13, and the lampshade heat-dissipation holes 111 in sequence.

Specifically, a battery 25, a mainboard 26 and other structures are arranged in the lamp housing 21, wherein the heat-dissipation fan 22, the lamp panel 24 and the battery 25 are all connected to the mainboard 26, and the battery 25 supplies power to the heat-dissipation fan 22 and the lamp panel 24 through the mainboard 26. The circuit on the mainboard 26 is designed as the prior art.

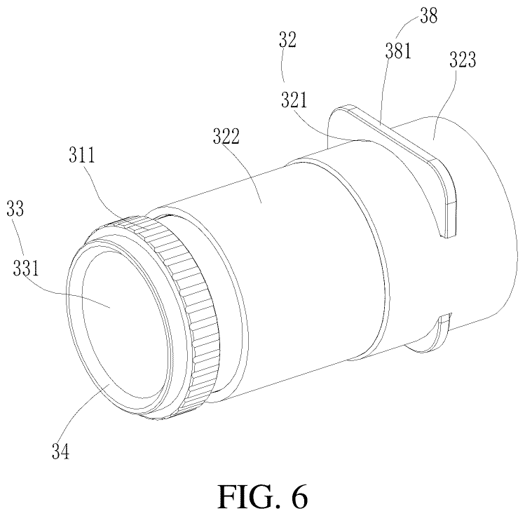

Referring to FIGS. 6-8, in this embodiment, the lens mechanism 3 includes a first cylinder 31, a second cylinder 32 and a lens group 33 including at least one lens; the first cylinder 31 is telescopically connected to the second cylinder 32; the at least one lens is arranged in the first cylinder 31; the first cylinder 31 is provided with a light outlet 34, the second cylinder 32 is provided with a light inlet 35, and the light inlet 35 and the light outlet 34 are communicated to form an optical channel; and the light inlet 35 corresponds to the light-condensing outlet 123.

During specific operation, the light emitted by the lamp panel 24 passes through the lampshade assembly 1, exits from the light-condensing outlet 123, enters the lens mechanism 3 from the light inlet 35, passes through the lens group 33 and exits from the light outlet 34. The first cylinder 31 is telescopically connected to the second cylinder 32, and the at least one lens is arranged in the first cylinder 31. The lens in the first cylinder 31 can be driven to move just by telescopically adjusting a position of the first cylinder 31, and then the emitted light can be focused. The overall focusing structure is simple and can be used with different light sources.

In this embodiment, the first cylinder 31 is in threaded connection with the second cylinder 32. The first cylinder 31 and the second cylinder 32 are connected through the threads and thus can be adjusted telescopically, such that the first cylinder 31 and the second cylinder 32 can ensure certain stability in a non-adjusted state, and the relative motion between the first cylinder 31 and the second cylinder 32 caused by accidental touch to a certain extent can be prevented.

In this embodiment, an outer wall of the first cylinder 31 is provided with an external thread 36, an inner wall of the second cylinder 32 is provided with an internal thread 37, and the external thread 36 is in threaded connection with the internal thread 37. Through the threaded connection between the external thread 36 and the internal thread 37, the first cylinder 31 can be telescopically connected to the inner wall of the second cylinder 32, and meanwhile the first cylinder 31 can be concealed, so that the overall surface flatness of the product is high.

In this embodiment, this lens mechanism further includes a projection assembly 38 provided with a pattern, wherein the projection assembly 38 is arranged in the second cylinder 32, and the projection assembly 38 is located in the optical channel. The projection assembly 38 is provided, such that different patterns (e.g., specific words projected on a wall) can be formed by illumination at the light outlet 34 conveniently in cooperation with a light source.

In this embodiment, the projection assembly 38 includes a baffle plate 381 and a projection pattern film 382, wherein the baffle plate 381 is provided with an optical through hole 3811, the projection pattern film 382 is detachably connected to the optical through hole 3811, and the baffle plate 381 is detachably connected into the second cylinder 32. Due to the above-mentioned structure, the projection pattern film 382 can be replaced conveniently to change a specific projection pattern and a projection effect. The detachable connection mode between the baffle plate 381 and the second cylinder 32 lies in that a through hole 321 is formed in at least one side of the second cylinder 32, and the baffle plate 381 can be inserted into the second cylinder 32 from the through hole 321, and can also be taken out from the second cylinder 32 through the through hole 321.

In this embodiment, the lens assembly 33 includes a front lens 331 and a middle lens 332, wherein the first cylinder 31 includes a lens adjusting cylinder 311 and a lens adjusting inner fixing ring 312; the front lens is mounted 331 in the lens adjusting cylinder 311; and the lens adjusting inner fixing ring 312 is mounted in the lens adjusting cylinder 311 and used to fixing the front lens 331. A specific fixing mode of the front lens 331 lies in that the lens adjusting inner fixing ring 312 is in threaded connection into the lens adjusting cylinder 311 against the front lens 331, so that such a structure can facilitate the disassembly and installation of the overall structure. Both the front and middle lenses are convex lenses.

In this embodiment, the second cylinder 32 includes a lens middle cylinder 322 and a body fixing cylinder 323, wherein the external thread 36 is arranged on the lens adjusting cylinder 311; the internal thread 37 is arranged on the lens middle cylinder 322; the lens middle cylinder 322 is in threaded connection with the body fixing cylinder 323; the middle lens 332 is arranged in the body fixing cylinder 323; the projection assembly 38 is arranged on the body fixing cylinder 323; the light outlet 34 is formed in the lens adjusting cylinder 311; and the light inlet 35 is formed in the body fixing cylinder 323.

The foregoing descriptions are merely preferred embodiments of the present application, and are not intended to limit the present application. Within the spirit and principles of the present application, any modifications, equivalent substitutions, improvements, etc., are within the protection scope of the present application.

1. A lampshade assembly, comprising a first lampshade and a second lampshade,
wherein the first lampshade is arranged to sleeve the outside of the second lampshade;
a lamp housing heat-dissipation channel is formed between the first lampshade and the second lampshade;
lampshade heat-dissipation holes that penetrate to the lamp housing heat-dissipation channel are formed in the first lampshade;
a light-condensing channel is arranged in the second lampshade;
one end of the light-condensing channel penetrates through one end of the second lampshade to form a light-condensing inlet corresponding to a lamp; and
the other end of the light-condensing channel runs through the other end of the second lampshade to form a light-condensing outlet.

2. The lampshade assembly according to claim 1, wherein the lamp housing heat-dissipation channel is encircled between the inner side of the first lampshade and the outer side of the second lampshade, and a plurality of lampshade heat-dissipation holes is encircled in the first lampshade.

3. The lampshade assembly according to claim 1, wherein the lampshade assembly further comprises a connector; the connector is arranged between the first lampshade and the second lampshade; and inner and outer sides of the connector are detachably connected to the second lampshade and the first lampshade respectively through threads.

4. The lampshade assembly according to claim 1, wherein the light-condensing inlet has a diameter less than a diameter of the light-condensing outlet.

5. A snoot tube, comprising a lamp mechanism, a lens mechanism, and the lampshade assembly according to claim 1, wherein the lamp mechanism and the lens mechanism are respectively arranged at two ends of the lampshade assembly, the lampshade assembly corresponds to the light-condensing inlet, and the lens mechanism corresponds to the light-condensing outlet.

6. The snoot tube according to claim 5, wherein the lamp mechanism and the lens mechanism are detachably arranged at two ends of the first lampshade respectively.

7. The snoot tube according to claim 5, wherein the lamp mechanism comprises a lamp housing, a heat-dissipation fan, a heat radiator, and a lamp panel; the lamp housing is detachably connected to the first lampshade; lamp heat-dissipation holes are formed in the lamp housing, and the heat-dissipation fan, the heat radiator and the lamp panel are all arranged in the lamp housing; the lamp panel is fixedly arranged on one side of the heat radiator; the heat-dissipation fan corresponds to the other side of the heat radiator; and the lamp panel corresponds to the light-condensing inlet; and
a heat-dissipation path is formed in the snoot tube, and the heat-dissipation path passes through the lamp heat-dissipation holes, the heat-dissipation fan, the heat radiator, the lamp panel, the lamp housing heat-dissipation channel, and the lampshade heat-dissipation hole in sequence.

8. The snoot tube according to claim 5, wherein the lens mechanism comprises a first cylinder, a second cylinder and a lens group comprising at least one lens; the first cylinder is telescopically connected to the second cylinder; the at least one lens is arranged in the first cylinder; the first cylinder is provided with a light outlet, the second cylinder is provided with a light inlet, and the light inlet and the light outlet are communicated to form an optical channel; and the light inlet corresponds to the light-condensing outlet.

9. A snoot tube, comprising a lamp mechanism, a lens mechanism, and the lampshade assembly according to claim 2, wherein the lamp mechanism and the lens mechanism are respectively arranged at two ends of the lampshade assembly, the lampshade assembly corresponds to the light-condensing inlet, and the lens mechanism corresponds to the light-condensing outlet.

10. The snoot tube according to claim 9, wherein the lamp mechanism and the lens mechanism are detachably arranged at two ends of the first lampshade respectively.

11. The snoot tube according to claim 9, wherein the lamp mechanism comprises a lamp housing, a heat-dissipation fan, a heat radiator, and a lamp panel; the lamp housing is detachably connected to the first lampshade; lamp heat-dissipation holes are formed in the lamp housing, and the heat-dissipation fan, the heat radiator and the lamp panel are all arranged in the lamp housing; the lamp panel is fixedly arranged on one side of the heat radiator; the heat-dissipation fan corresponds to the other side of the heat radiator; and the lamp panel corresponds to the light-condensing inlet; and
a heat-dissipation path is formed in the snoot tube, and the heat-dissipation path passes through the lamp heat-dissipation holes, the heat-dissipation fan, the heat radiator, the lamp panel, the lamp housing heat-dissipation channel, and the lampshade heat-dissipation hole in sequence.

12. The snoot tube according to claim 9, wherein the lens mechanism comprises a first cylinder, a second cylinder and a lens group comprising at least one lens; the first cylinder is telescopically connected to the second cylinder; the at least one lens is arranged in the first cylinder; the first cylinder is provided with a light outlet, the second cylinder is provided with a light inlet, and the light inlet and the light outlet are communicated to form an optical channel; and the light inlet corresponds to the light-condensing outlet.

13. A snoot tube, comprising a lamp mechanism, a lens mechanism, and the lampshade assembly according to claim 3, wherein the lamp mechanism and the lens mechanism are respectively arranged at two ends of the lampshade assembly, the lampshade assembly corresponds to the light-condensing inlet, and the lens mechanism corresponds to the light-condensing outlet.

14. The snoot tube according to claim 13, wherein the lamp mechanism and the lens mechanism are detachably arranged at two ends of the first lampshade respectively.

15. The snoot tube according to claim 13, wherein the lamp mechanism comprises a lamp housing, a heat-dissipation fan, a heat radiator, and a lamp panel; the lamp housing is detachably connected to the first lampshade; lamp heat-dissipation holes are formed in the lamp housing, and the heat-dissipation fan, the heat radiator and the lamp panel are all arranged in the lamp housing; the lamp panel is fixedly arranged on one side of the heat radiator; the heat-dissipation fan corresponds to the other side of the heat radiator; and the lamp panel corresponds to the light-condensing inlet; and
a heat-dissipation path is formed in the snoot tube, and the heat-dissipation path passes through the lamp heat-dissipation holes, the heat-dissipation fan, the heat radiator, the lamp panel, the lamp housing heat-dissipation channel, and the lampshade heat-dissipation hole in sequence.

16. The snoot tube according to claim 13, wherein the lens mechanism comprises a first cylinder, a second cylinder and a lens group comprising at least one lens; the first cylinder is telescopically connected to the second cylinder; the at least one lens is arranged in the first cylinder; the first cylinder is provided with a light outlet, the second cylinder is provided with a light inlet, and the light inlet and the light outlet are communicated to form an optical channel; and the light inlet corresponds to the light-condensing outlet.

17. A snoot tube, comprising a lamp mechanism, a lens mechanism, and the lampshade assembly according to claim 4, wherein the lamp mechanism and the lens mechanism are respectively arranged at two ends of the lampshade assembly, the lampshade assembly corresponds to the light-condensing inlet, and the lens mechanism corresponds to the light-condensing outlet.

18. The snoot tube according to claim 17, wherein the lamp mechanism and the lens mechanism are detachably arranged at two ends of the first lampshade respectively.

19. The snoot tube according to claim 17, wherein the lamp mechanism comprises a lamp housing, a heat-dissipation fan, a heat radiator, and a lamp panel; the lamp housing is detachably connected to the first lampshade; lamp heat-dissipation holes are formed in the lamp housing, and the heat-dissipation fan, the heat radiator and the lamp panel are all arranged in the lamp housing; the lamp panel is fixedly arranged on one side of the heat radiator; the heat-dissipation fan corresponds to the other side of the heat radiator; and the lamp panel corresponds to the light-condensing inlet; and
a heat-dissipation path is formed in the snoot tube, and the heat-dissipation path passes through the lamp heat-dissipation holes, the heat-dissipation fan, the heat radiator, the lamp panel, the lamp housing heat-dissipation channel, and the lampshade heat-dissipation hole in sequence.

20. The snoot tube according to claim 17, wherein the lens mechanism comprises a first cylinder, a second cylinder and a lens group comprising at least one lens; the first cylinder is telescopically connected to the second cylinder; the at least one lens is arranged in the first cylinder; the first cylinder is provided with a light outlet, the second cylinder is provided with a light inlet, and the light inlet and the light outlet are communicated to form an optical channel; and the light inlet corresponds to the light-condensing outlet.
